(19) United States
(12) Patent Application Publication
(10) Pub. No.: US 2005/0006911 A1
(43) Pub. Date: Jan. 13, 2005

(54) Adjustable latch assembly

(76) Inventor: Wen-Pin Wu, Kaohsiung Hsien (TW)

Correspondence Address: BIRCH STEWART KOLASCH & BIRCH, PO BOX 747, FALLS CHURCH, VA, 22040-0747, US

(21) Appl. No.: 10/854,277

(22) Filed: May 27, 2004

(30) Foreign Application Priority Data
Sep. 10, 2002 (TW) 91214429

(51) Int. Cl. E05B 9/00

(52) U.S. Cl. 292/337

(57) ABSTRACT

An adjustable latch assembly includes a cylindrical housing to accommodate a deadbolt which has a first notch and a second notch. Correspondingly, each of the assembling plates has an assembling hole and an adjusting groove. Two assembling plates are inserted into an adjustable casing which includes an axial hole, a pair of assembling holes and a passage. A pulling member is sandwiched in between the two assembling plates, and has a through hole in which to extend an engaging arm of an actuating cam. A push-button member is movably received in the passage of the adjustable casing, and has an inclined surface. In adjusting operation, the inclined surface of the push-button member moves upward a bottom edge of the pulling member so that a shoulder of the pulling member is disengaged from either of the first notch or the second notch of the connecting plate.

### BACKGROUND OF THE INVENTION

1. Field of the Invention

The present invention relates to an adjustable latch assembly which has an adjustable device and a simplified structure for adjusting an assembling distance.

2. Description of the Related Art

Referring initially to FIG. 7, applicant's own Taiwanese Pat. Publication No. 147,136, titled “AUXILIARY LOCK WITH AN EXTENSIBLE DEVICE,” corresponding to U.S. Pat. No. 4,957,315 discloses a latch assembly including a cylindrical housing 90 contained a deadbolt 91. A bottom portion of the cylindrical housing 90 connects with a pair of assembling plates 92 on which to sleeve a casing 93. An actuating cam 94 is sandwiched in between the two assembling plates 92, and connected with a pulling member 95 through an adapter 98 for synchronous movement. The pulling member 95 further includes a shoulder portion 951 adapted to selectively engage with one of a first notch 961 and a second notch 962 of a connecting plate 96. An end of the connecting plate 96 pivot-connects with a bottom portion of the deadbolt 91.

In adjusting operation, a push-button member 97 is employed to disengage the pulling member 95 from the connecting plate 96. The push-button member 97 has an inclined wall 971 which is engaged with a bottom edge 952 of the pulling member 95. When the push-button member 97 is pushed, the inclined wall 971 of the push-button member 97 may move upward the bottom edge 952 of the pulling member 95. After pushing the push-button member 97 a predetermined distance, the shoulder portion 951 of the pulling member 95 may be disengaged from either of the first notch 961 or the second notch 962 of the connecting plate 96. Consequently, the disengagement permits adjusting an assembling distance of the latch assembly.

However, the latch assembly employs the adapter 98 to connect the actuating cam 94 with the pulling member 95 that may complicate the entire structure and manufacture process of the latch assembly. Also, the complicated structure of the latch assembly may result in an increase of manufacture cost. Furthermore, the adapter 98 connected between the actuating cam 94 and the pulling member 95 is protruded from a top portion of the casing 93 that may cause the latch assembly to increase its dimensions. Consequently, the increased dimensions of the latch assembly may result in an inconvenience for assembling on a doorplate. Also, the latch assembly may be unsuitable for some particular specification of the doorplate.

### SUMMARY OF THE INVENTION

The primary objective of this invention is to provide an adjustable latch assembly which can conveniently adjust an assembling distance, and simplify the entire structure for speeding manufacture time and reducing manufacture cost.

The adjustable latch assembly in accordance with the present invention includes a cylindrical housing having a first end and a second end. The first end of the cylindrical housing connects a faceplate while the second end forming a connecting slot. Two assembling plates are arranged in parallel and mechanically mounted in the connecting slot. The cylindrical housing accommodates a deadbolt connecting with a connecting plate which has a first notch and a second notch. Correspondingly, each of the assembling plates has an assembling hole and an adjusting groove. The two assembling plates are inserted into an adjustable casing which includes an axial hole, a pair of assembling holes and a passage. A pulling member is sandwiched in between the two assembling plates, and has a through hole in which to extend an engaging arm of an actuating cam. A push-button member is movably received in the passage of the adjustable casing, and has a pushing rod and an inclined surface thereof. In adjusting operation, the inclined surface of the push-button member moves upward a bottom edge of the pulling member so that a shoulder of the pulling member is disengaged from either of the first notch or the second notch of the connecting plate.

Other objectives, advantages and novel features of the invention will become more apparent from the following detailed description and the accompanying drawings.

### BRIEF DESCRIPTION OF THE DRAWINGS

The present invention will now be described in detail with reference to the accompanying drawings wherein:

FIG. 1 is an exploded perspective view of an adjustable latch assembly in accordance with a preferred embodiment of the present invention;

FIG. 2 is a partial cross-sectional view of the adjustable latch assembly in a retracted position in accordance with the preferred embodiment of the present invention;

FIG. 3 is a cross-sectional view, taken along line 3-3 in FIG. 2, of the adjustable latch assembly in accordance with the preferred embodiment of the present invention;

FIG. 4 is a cross-sectional view, similar to that shown in FIG. 3, of the adjustable latch assembly in adjusting operation in accordance with the preferred embodiment of the present invention;

FIG. 5 is a cross-sectional view, similar to that shown in FIG. 2, of the adjustable latch assembly in adjusting operation in accordance with the preferred embodiment of the present invention;

FIG. 6 is a partial cross-sectional view, similar to that shown in FIG. 2, of the adjustable latch assembly in an extended position in accordance with the preferred embodiment of the present invention; and

FIG. 7 is an exploded perspective view of a conventional latch assembly in accordance with the prior art.

### REFERENCE NUMERAL

| | | | |
|---|---|---|---|
| 1 | cylinder housing | 12 | faceplate |
| 13 | fixing ring | 14 | connecting slot |
| 2 | deadbolt | 21 | groove |
| 22 | connecting plate | 221 | first notch |
| 222 | second notch | 223 | limiting rod |
| 224 | guide rod | 23 | fixing pin |
| 3 | assembling plate | 31 | assembling hole |
| 311 | first recessed edge | 312 | second recessed edge |
| 32 | longitudinal slot | 33 | protrusion |
| 34 | adjusting groove | 35 | numeral mark |
| 4 | adjustable casing | 41 | longitudinal slot |
| 42 | axial hole | 43 | assembling hole |
| 44 | passage | 45 | examining hole |
| 5 | pulling member | 51 | shoulder |
| 52 | through hole | 53 | elastic member |
| 54 | positioning lug | | |
| 6 | actuating cam | 60 | flat outer edge |
| 61 | engaging arm | 62 | elastic member |
| 7 | push-button member | 71 | limit member |
| 72 | pushing rod | 73 | inclined surface |
| 74 | coil spring | 75 | protrusion member |

### DETAILED DESCRIPTION OF THE INVENTION

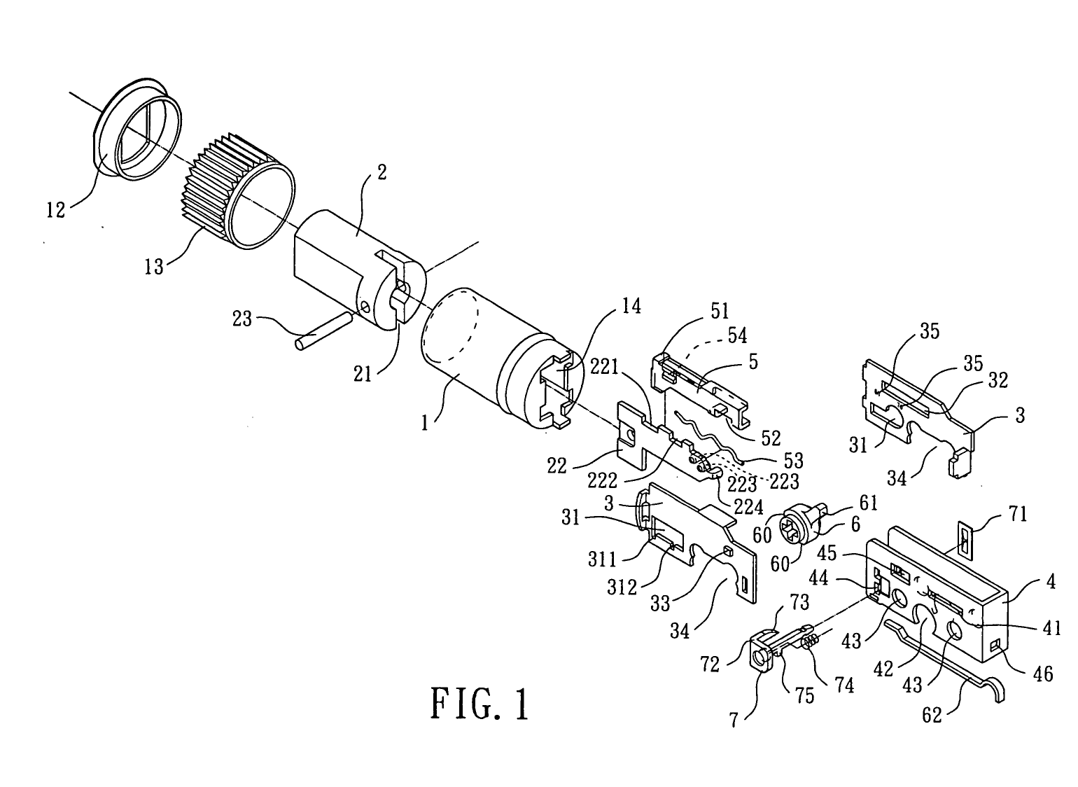

Referring initially to FIG. 1, an adjustable latch assembly in accordance with a preferred embodiment of the present invention includes a cylindrical housing 1, a deadbolt 2, a pair of assembling plate 3, an adjustable casing 4, a pulling member 5, an actuating cam 6 and a push-button member 7.

Referring again to FIG. 1, the cylindrical housing 1 provides with an opening end at its first end and accommodates the deadbolt 2 which can be slidably extended from the opening end of the cylindrical housing 1. After the cylindrical housing 1 has accommodated the deadbolt 2, the opening end of the cylindrical housing 1 further connects with a faceplate 12 that prevents from removal of the deadbolt 2. Preferably, the faceplate 12 can be selected from a rectangle-shaped or circle-shaped member. The cylindrical housing 1 employs a fixing ring 13 to sleeve its outer surface and to rotatably adjust a predetermined position about an axis line. Thus, the fixing ring 13 can securely mount the cylindrical housing 1 in a positioning hole of a doorplate. Furthermore, the cylindrical housing 1 further provides with a connecting slot 14 at its second end. The connecting slot 14 mechanically connects with the assembling plates 3.

The deadbolt 2 is confined within the cylindrical housing 1 to prevent from removal. The deadbolt 2 has an end and a groove 21 thereof to connect to a connecting plate 22 by a fixing pin 23. The connecting plate 22 has a first notch 221 and a second notch 222 spaced apart in series.

The assembling plates 3 consist of two plate members arranged in parallel. The two assembling plates 3 is mechanically mounted in the connecting slot 14 of the cylindrical housing 1, and each of the assembling plates 3 has an assembling hole 31 and an adjusting groove 34. One of the assembling plates 3 provides with a first recessed edge 311 and a second recessed edge 312 in the assembling hole 31. The other assembling plate 3 provides with a longitudinal slot 32 adapted to receive a guide rod 224 of the connecting plate 22 so that movements of the connecting plate 22 is limited in the guide slot 32 of the assembling plate 5.

The adjustable casing 4 is slidably mounted on the two assembling plates 3. In order to limit the adjusting movement of the adjustable casing 4 along a predetermined path with respect to the assembling plates 3, the adjustable casing 4 provides with a longitudinal slot 41 to receive a protrusion 33 of the assembling plate 3. The adjustable casing 4 further includes an axial hole 42, a pair of assembling holes 43 and a passage 44. In adjusting operation, moving the adjustable casing 4 with respect to the assembling plates 3, the axial hole 42 of the adjustable casing 4 exactly aligns with one of two distal ends of the adjusting groove 34. Each of the assembling holes 43 locates at either side of the axial hole 42. To clearly examine the adjusting movement of the-adjustable casing 4, the adjustable casing 4 further provides with an examining hole 45 for displaying numeral marks 35 of the assembling plate 3. After moving the adjustable casing 4 with respect to the assembling plates 3, moving the adjustable casing 4 with respect to the assembling plates 3, the examining hole 45 of the adjustable casing 4 aligns with the corresponding numeral mark 35.

The pulling member 5 has a predetermined length. The pulling member 5 includes a first end forming a shoulder 51 selectively engaged with one of the first notch 221 or the second notch 222 of the connecting plate 22. And the pulling member 5 includes a second end forming a through hole 52 engaged with an engaging aim 61 of the engaging cam 6. To insure the engagement of the pulling member 5 with the connecting plate 22, one end of an elastic member 53 bias a positioning lug 54 of the pulling member 5 while the other end of the elastic member 53 engaging in two limiting rods 223 of the connecting plate 22. Thus, the shoulder 51 of the pulling member 5 is forcibly engaged with one of the first notch 221 or the second notch 222 of the connecting plate 22.

The actuating cam 6 is rotatably received in the axial hole 42 of the adjustable casing 4 and driven to rotate a predetermined angular movement by an actuating rod of a lock mechanism (not shown). Since the engaging arm 61 of the actuating cam 6 engages with the through hole 52 of the pulling member 5, the actuating cam 6 can move a predetermined longitudinal movement of the pulling member 5. To position the angular movement of the actuating cam 6, an elastic member 62 can selectively limit one of two flat outer edges 60 of the actuating cam 6. Preferably, one distal end of the elastic member 62 is securely extended into an aperture 46 of the adjustable casing 4.

Turning now to FIGS. 1, 3 and 4, the push-button member 7 extends through the passage 44 of the adjustable casing 4 and the assembling hole 31 of the assembling plates 3. The push-button member 7 includes a pushing rod 72 and an inclined surface 73 thereof. The inclined surface 73 of the push-button member 7 engages with a bottom edge of the pulling member 5. In operation, pressing the push-button member 7, the inclined surface 73 of the push-button member 7 moves upward the pulling member 5 that the shoulder 51 of the pulling member 5 is disengaged from either of the first notch 221 or the second notch 222 of the connecting plate 22. To return the pressing movement of the push-button member 7, a biasing force of a coil spring 74 is employed to return the push-button member 7. Consequently, once the press force is removed, the push-button member 7 can return to an original position. To accomplish a preferred positioning effect, the push-button member 7 further includes a protrusion member 75 selectively engaged with one of the first recessed edge 311 or the second recessed edge 312 of the assembling hole 31 of the assembling plate 3. Preferably, a limit member 71 snap-connects with a distal end of the push-button member 7 to thereby prevent removing from the adjustable casing 4.

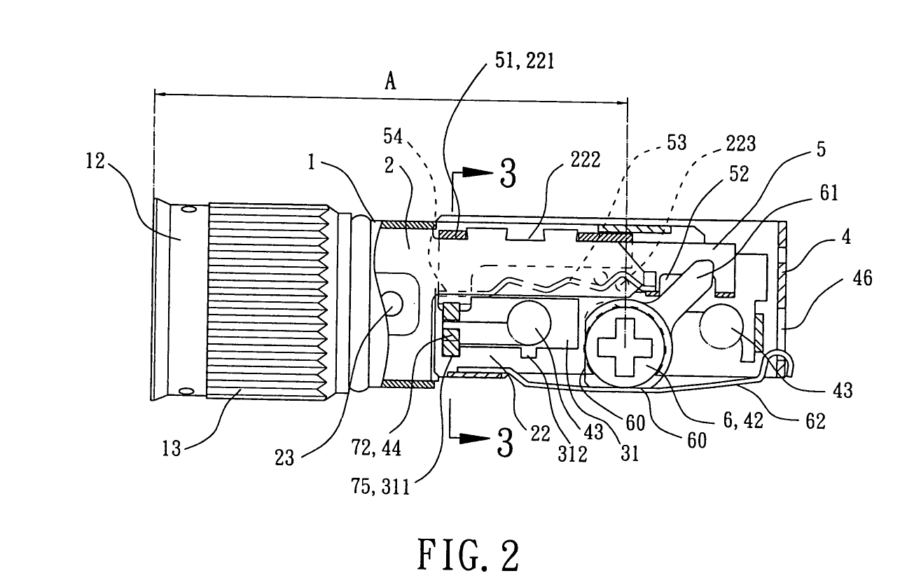

Turning now to FIG. 2, when the adjustable latch assembly is situated in a shorter assembling distance, the faceplate 12 and an axis of the actuating cam 6 is spaced a shorter distance (A). At that time, the entire deadbolt 2 is retracted in the cylindrical housing 1 and situated in the retracted position. Meanwhile, the shoulder 51 of the pulling member 5 is biased by the elastic member 53 and forcibly engaged with the first notch 221 of the connecting plate 22. Correspondingly, the engaging arm 61 of the actuating cam 5 extends into the through hole 52 of the pulling member 5. In locking operation, a counterclockwise rotation of the actuating cam 6 may drive to extend the deadbolt 2 from the faceplate 12 of the cylindrical housing 1 through the pulling member 5 and the connecting plate 22.

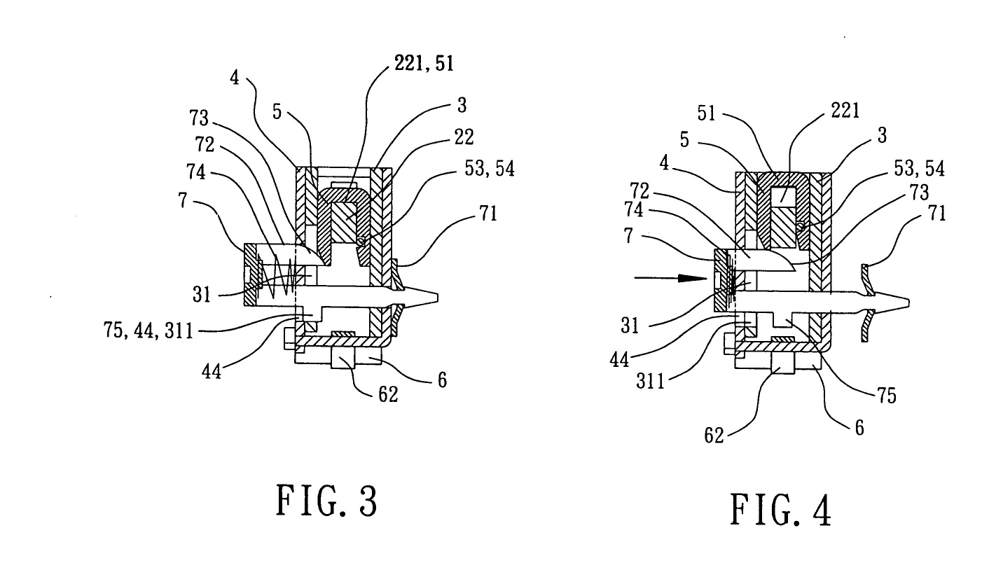

Referring back to FIG. 3, when the push-button member 7 is not yet pressed and biased by the coil spring 74, the inclined surface 73 of the push-button member 7 is unable to actuate an upward movement of the first end of the pulling member 5. Thus, the shoulder 51 of the pulling member 5 is remained in the first notch 221 of the connecting plate 22. Consequently, an adjusting movement of the adjustable casing 4 is not allowed.

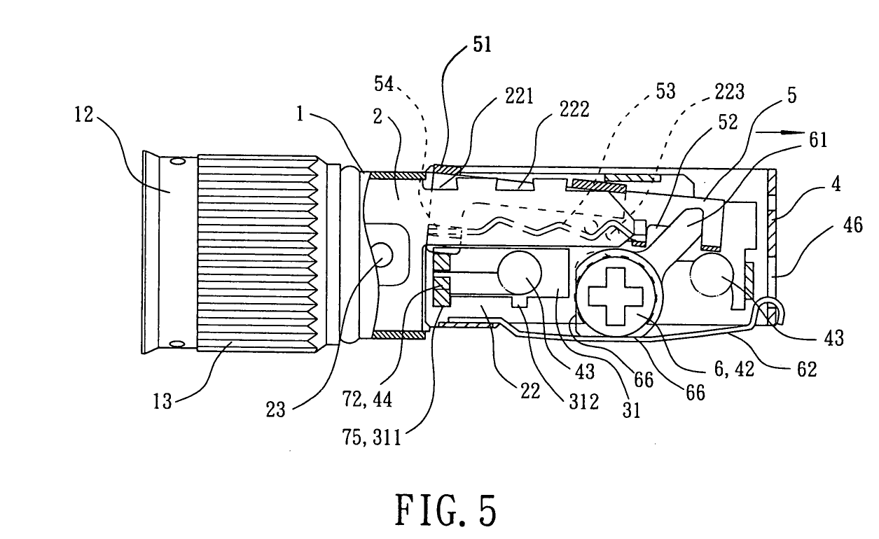

Referring back to FIG. 4, when the adjustable latch assembly is converted a smaller distance into a larger distance, the push-button member 7 must be pressed. The inclined surface 73 of the push-button member 7 may drive an upward movement of the first end of the pulling member 5 so that the shoulder 51 of the pulling member 5 disengages from the first notch 221 of the connecting plate 22, as best shown in FIG. 5. Consequently, an adjusting movement of the adjustable casing 4 is allowed to move away from the cylindrical housing 1.

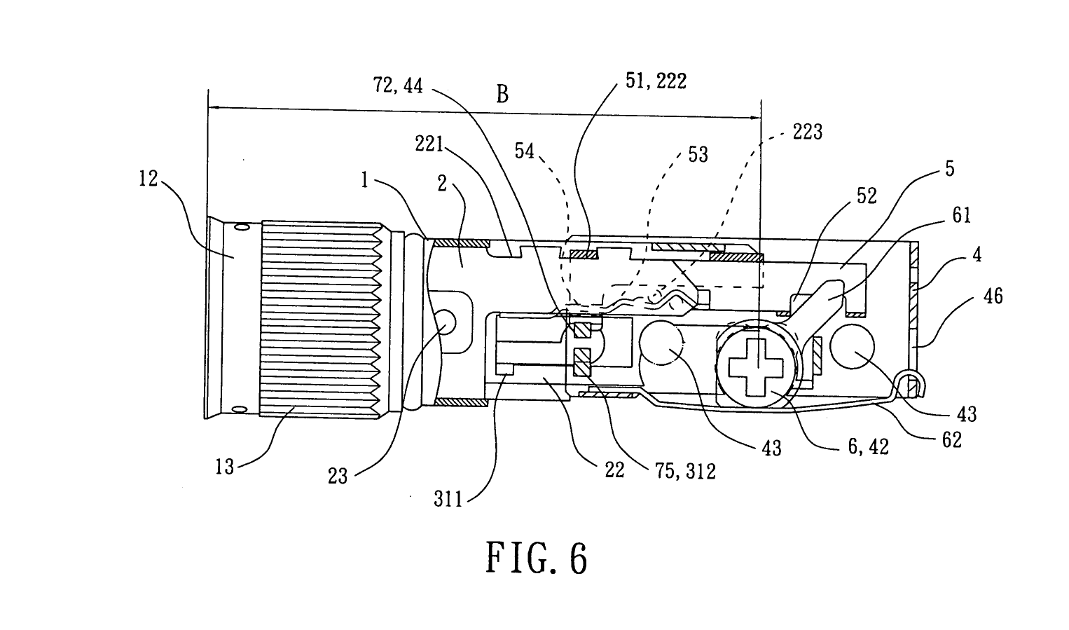

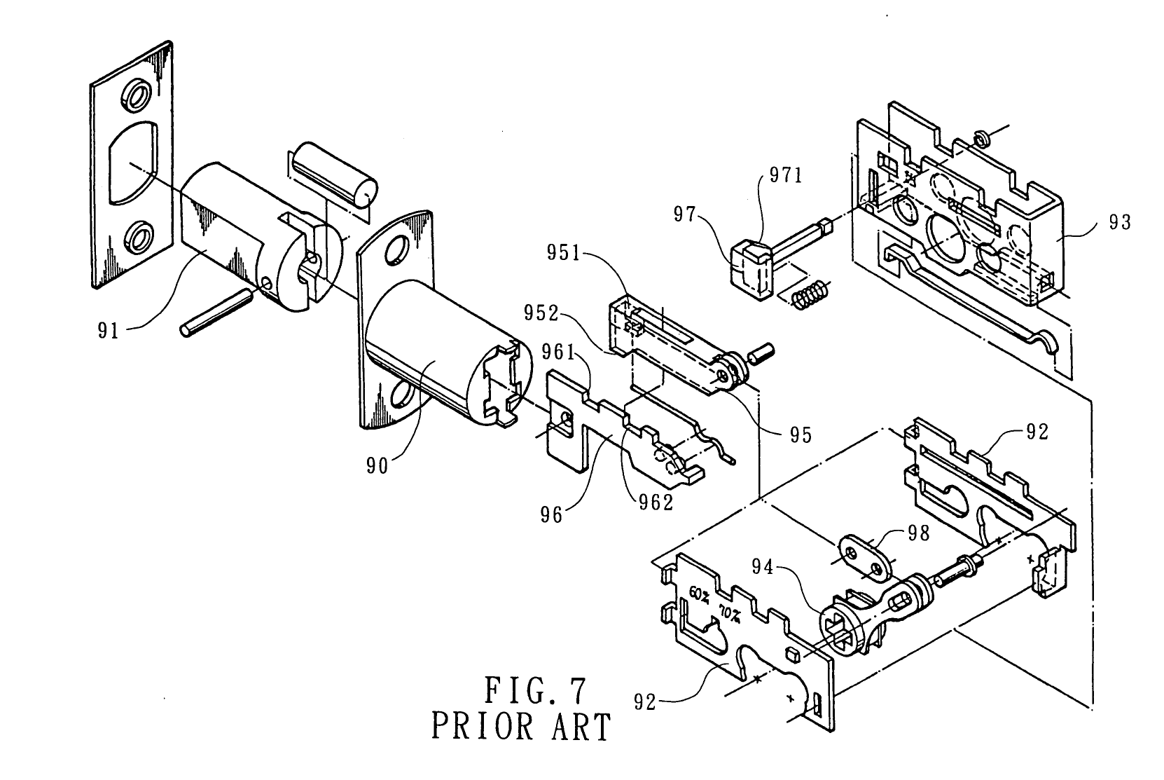

Turning now to FIG. 6, when the adjustable casing 4 is positioned, the shoulder 51 of the pulling member 5 is engaged with the second notch 222 of the connecting plate 22. Thereby, the adjustable latch assembly is situated in a greater assembling distance, and the faceplate 12 and the axis of the actuating cam 6 is spaced a greater distance (B).

Referring back to FIGS. 1, 2, 5 and 6, at least one of the assembling plates 3 preferably includes a limiting top plate (not labeled) to extend in horizontal. The limiting top plate covers an inner space defined between the assembling plates 3 and the adjustable casing 4 so that it can prevent the actuating cam 5 protruding from the assembling plates 3 and the adjustable casing 4 while assembling the latch assembly. Referring back to FIG. 7, the actuating cam 94, the pulling member 95 and the adapter 98 may protrude out of the adjustable casing 4 that obstructs the assembling operation on an assembling hole of a doorplate. In comparison with the present invention, the latch members of the conventional latch assembly may affect the assembling operation.

However, the adjustable latch assembly of the present invention accomplishes the direct connection of the pulling member 5 to the actuating cam 7. And the shoulder 51 of the pulling member 5 selectively engages with the first notch 221 or the second notch 222 of the connecting plate 22. Consequently, in adjusting operation, it may simplify the entire structure for speeding manufacture time and reducing manufacture cost.

Although the invention has been described in detail with reference to its presently preferred embodiment, it will be understood by one of ordinary skill in the art that various modifications can be made without departing from the spirit and the scope of the invention, as set forth in the appended claims.

1. An adjustable latch assembly, comprising:
a cylindrical housing including a first end connecting with a faceplate, and a second end forming a connecting slot;
a deadbolt received in the cylindrical housing, the deadbolt having a first end to extend or retract from the cylindrical housing, and a second end connecting to a connecting plate, the connecting plate including a first notch and a second notch;
a pair of assembling plates each including an assembling hole and an adjustable groove, at least one of the assembling plates including a limiting top plate;
an adjustable casing adapted to receive the assembling plates and including an axial hole and a passage;
a pulling member including a first end having a shoulder selectively engaged with the first notch or the second notch of the connecting plate, and a second end having a through hole, the limiting top plate of the assembling plate covers the pulling member so that the pulling member is completely received in an inner space defined between the assembling plates and the adjustable casing;
an actuating cam rotatably mounted in the axial hole of the adjustable casing, the actuating cam including an engaging arm extended in the through hole of the pulling member; and
a push-button member extended through the passage of the adjustable casing and the assembling hole of the assembling plate, the push-button member including an inclined surface adapted to engage with a bottom edge of the pulling member so as to allow the shoulder of the pulling member disengaging from the first notch or the second notch of the connecting plate.

2. The adjustable latch assembly as defined in claim 1, further comprising a fixing ring to sleeve on an outer surface of the cylindrical housing.

3. The adjustable latch assembly as defined in claim 1, wherein the assembling hole of the assembling plate includes a first recessed edge and a second recessed edge engaged with a protrusion member of the push-button member.

4. The adjustable latch assembly as defined in claim 1, wherein at least one of the assembling plates includes a longitudinal slot to receive a guide rod of the connecting member to guide a longitudinal movement of the connecting member.

5. The adjustable latch assembly as defined in claim 1, wherein one of the assembling plates includes a protrusion received in a longitudinal slot of the adjustable casing to guide an adjusting movement of the adjustable casing.

6. The adjustable latch assembly as defined in claim 1, wherein at least one of the assembling plates includes numeral marks, and correspondingly the adjustable casing includes an examining hole for displaying the numeral marks of the assembling plate.

7. The adjustable latch assembly as defined in claim 1, further comprising an elastic member arranged between the connecting plate and the pulling member, one end of the elastic member bias a positioning lug of the pulling member while the other end of the elastic member engaging in two limiting rods of the connecting plate, and thus the shoulder of the pulling member is forcibly engaged with one of the first notch or the second notch of the connecting plate.

8. The adjustable latch assembly as defined in claim 1, further comprising an elastic member selectively engaged with one of two flat outer edges of the actuating cam.

9. The adjustable latch assembly as defined in claim 1, further comprising a coil spring arranged between the adjustable casing and the push-button member that the push-button member can be returned.
